(19) United States
(12) Patent Application Publication
(10) Pub. No.: US 2014/0289070 A1
(43) Pub. Date: Sep. 25, 2014

(54) BUYER-SELLER MATCHING METHOD

(71) Applicant: Bryan K. Copley, Auburn, WA (US)

(72) Inventor: Bryan K. Copley, Auburn, WA (US)

(21) Appl. No.: 14/224,033

(22) Filed: Mar. 24, 2014

Related U.S. Application Data
(60) Provisional application No. 61/804,726, filed on Mar. 24, 2013.

(51) Int. Cl. G06Q 50/16; G06Q 30/06

(52) U.S. Cl. CPC G06Q 50/16; G06Q 30/0631
USPC 705/26.7

(57) ABSTRACT

An inventive two-tiered buyer-seller matching method directed to property transactions is disclosed herein. The inventive method matches buyers that are recruited on an internet website to list criteria for desired real estate properties. Sellers of property are similarly recruited to list the property. In a first matching tier, a cohort of matched buyers is chosen by matching basic property descriptors entered by buyers and sellers. As a further refinement to the first tier of the matching process, a second tier function of the inventive method ranks individual buyers in the cohort by the overall importance of the selected property features that are common to that buyer's choices and to the seller. A list comprising the cohort of buyers ordered by the ranking score is then presented to the seller. In this manner, the seller is provided with a knowledge of which buyers would potentially be most interested in the property for sale, and is thereby provided with a basis upon which one or more of high potential buyers may be contacted with an offer to sell.

### CROSS REFERENCE TO RELATED PROVISIONAL APPLICATION

This utility application claims the benefit of U.S. Provisional Application No. 61/804,726 filed on Mar. 24, 2013.

### FIELD OF THE INVENTION

The invention relates to web-based buyer-seller matching methods for property transactions.

### BACKGROUND

The real estate industry has inefficiently connected buyers and sellers for decades using a seller-initiated transaction origination approach. This approach endeavors to make potential buyers aware of a home for sale and then coax the buyer into looking at and then buying the home. Several websites exist for enhancing the efficiency of real estate transactions, buyer searches of existing inventory, agents, and seller searches for buyers. At the time of this writing, examples include FindBuyers.com, galgil.com and homeCloud.com. U.S. Pat. No. 8,140,442 to Heyer discloses an internet-based method to match real properties not currently listed for sale to buyers searching in the real estate market. The method disclosed therein ranks both buyers and property owners using a ready, willing and able attribute when a potential match is found by matching the criteria expressed by both the buyers and sellers. This method is buyer dominant in that sellers are not recruited. The inventory of all homes, for sale or not, in particular neighborhoods is listed with descriptions, and made available in a database viewable by registered buyers. Buyers rate themselves as to their degree of readiness, willingness and ability to purchase homes they view in the inventory. Where there is interest in a particular real property, the owner is contacted and also self-rated as to their readiness, willingness and ability to sell. This method does not actively recruit active sellers, therefore the success rate for buyers to find a home from the inventory of existing homes is low.

U.S. Pat. No. 8,196,811 to Mesaros discloses a multiple criteria internet-based buyer and seller pairing method for both real and personal property transactions. In this method, both registered buyer and seller transactional criteria are cataloged and compared. Goods for sale by a seller are made known to registered buyers in the market for those goods, and registered buyers in the market for certain goods are matched to a seller offering the same or similar goods, wherein the particular criteria of both buyers and sellers are ‘matched’. However, there is no ranking of matches in this particular scheme, therefore the quality of matches is random.

### SUMMARY

The present invention is a two-tiered internet-based buyer-seller matching method that provides enhanced matches between a property owner offering a property for sale with one or more qualified potential buyers. Both the buyers and the property owner have previously registered on an internet-based interface (henceforth referred to a the website or buyer-seller matching website) for the software for executing the algorithm embodying the inventive method, providing criteria for buying and selling. Sellers registering on the website may provide basic information about the offered property, for example a home, such as a sales price range, living space square footage, number of bedrooms, baths, etc. The basic information provided by the seller is a first set of descriptors that may be used in the first tier of the matching process of the inventive method.

In addition to the first set of descriptors about the property, the seller may provide a second set of descriptors that comprises attribute descriptors connected to the property for sale, such as the presence of a patio, a swimming pool, a deck, a view, and the like. To provide the second set of descriptor, sellers may be presented with a plurality of attributes that are provided on a web interface page connected to the buyer-seller matching website. Sellers may select attributes that apply to the offered property from the plurality of attributes by the use of check boxes or radio buttons associated with each of the attributes.

Accordingly, buyers provide reciprocal first set descriptors, such as the price range that they are willing to consider, how much square footage they desire, how many bedrooms, baths and parking spaces in a garage they desire. Buyers may also be presented with a plurality of property attributes, which may the same as those presented to the sellers, in order to provide a second set of reciprocal s. It is an object of the preferred embodiment of the invention that buyers may further score the importance that each of the property attributes holds for the buyer, in the form of a numerical score value that may be entered by the buyer at the time of completing the search criteria entries. The importance score values are chosen subjectively according to the buyer's preferences, whereby the buyer may select a numerical score from a choice of numbers ranging between, for example, 1-5.

Accordingly, the inventive two-tiered buyer-seller matching method comprises two levels of filtration for providing a list of qualified buyers to a property owner. After a first filtration step based on matching the first set of search criteria inputs by the inventive algorithm, a cohort of buyers is selected from the plurality of all buyers registered on the website. Subsequently, a second filtration step is executed. In the second filtration step, the inventive algorithm refines the matched buyers from the cohort of buyers selected in the first filtering step, whereby the matched buyers are now ranked according to the importance scores that they placed on the property attributes that were common with the seller's selection.

According to the inventive method, buyers in the cohort are ranked by summing the importance score values for each buyer. A list of the ranked buyers is then compiled, wherein the buyers are listed in order of their ranking, the list then presented to the seller as a list of qualified buyers ranked in order of highest probability of transaction. In this manner, the seller is provided with a knowledge of which buyers would potentially be most interested in the property for sale, and is thereby provided with a basis upon which one or more of high potential buyers may be contacted with an offer to sell. The list may be sent to the seller by an automatically generated e-mail created in a function of the website software embodying the inventive method algorithm. Alternatively, the list may be made available to the seller by a personalized webpage featuring the list of qualified and ranked buyers, from which the seller may select any number of qualified buyers for contact. Contact with buyers may be initiated in a variety of ways by the seller, but the seller has the choice of whom he or she may want to contact. In other embodiments, the additional filter of lender pre-approval may be used to narrow the buyer cohort to only pre-approved buyers.

It is another object of the invention to make accessible to potential buyers properties that do not appear in any sales listing. As an example, all properties in a specific neighborhood may be contained in a database maintained by the buyer-seller matching website, wherein most of the property owners may not have considered selling their properties, therefore the properties are not currently for sale. Potential buyers may browse the buyer-seller matching website for these unlisted properties. This method is particularly advantageous for potential buyers that are considering relocating to a new city or neighborhood, and do not live close to the area. Also buyers that do live locally may peruse all the homes in a neighborhood and indicate interest in one or more homes they would desire to purchase if it were for sale. A potential buyer may also look up a home that he or she has been eyeing to find vital statistics about the home that are presented to the buyer in a manner that may be more informative and convenient than having to discern the same information from county tax records. In this way, the method allows every property to virtually be “on the market”.

Advantageously, the innovative buyer-seller matching provides for both buyers and sellers far less labor and capital expenditure per ‘match’ or potential sale than is currently required by conventional means to achieve the same result. Instead of conducting multiple searches or queries for a home online, buyers can enter their specifications one time, and get automatic updates as the market changes. Sellers can enter the specifications of their home online and proactively reach out to qualified buyers whose profiles match their home, and moreover have a ranking of these qualified buyers based on the probability of transaction.

### BRIEF DESCRIPTION OF THE DRAWINGS

FIG. 1. Example of a new user registration screen for a website interface.

FIG. 2. Buyer profile creation screen example.

FIG. 3. Seller property profile creation screen example.

FIG. 4. Inventive buyer-seller matching algorithm subroutine flowchart.

FIG. 5. Seller's supplementary property descriptor to matched buyer screen.

FIG. 6. Example of match e-mail to buyer.

FIG. 7. A flow chart example of the overarching software kernel.

### DETAILED DESCRIPTION

The software component of the invention that enables the website interface comprises the inventive two-tiered buyer-seller matching algorithm described in detail below. The website interface enables user input to the software routines that comprise the inventive algorithm to be captured via internet link to one or more servers hosting the website software. The graphical user interface (GUI) of the website provides a homepage to describe the services offered. It is understood by persons skilled in the art that the website serves as an interface, more specifically the GUI, to allow interactive access by an interested user to the software component of the invention. The software component of the invention may be hosted on one or more servers maintained by an administrator, and therefore is stored in physical memory that may be locally situated at the location of the one or more servers such as on a hard drive within the physical server, and executed by microprocessors also located in the servers.

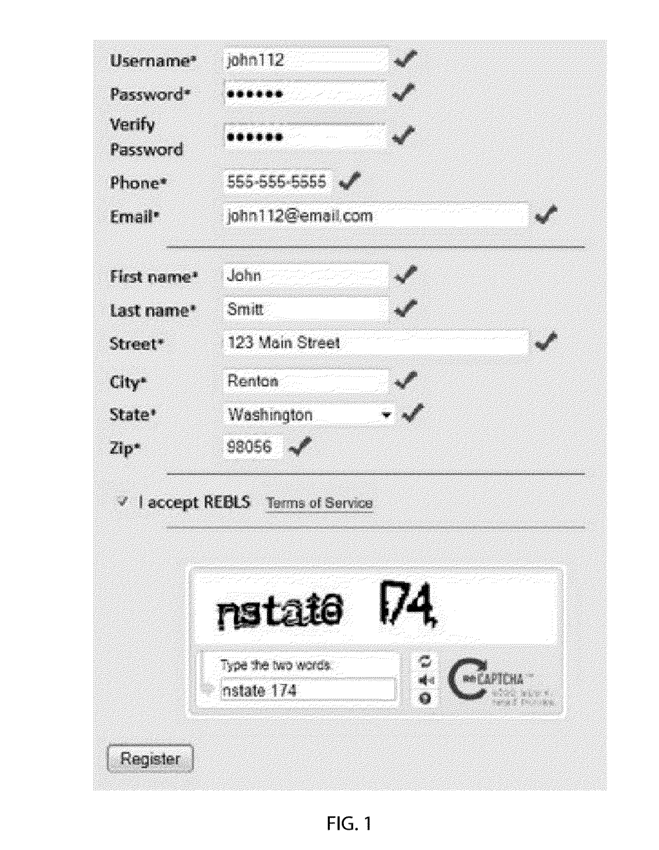

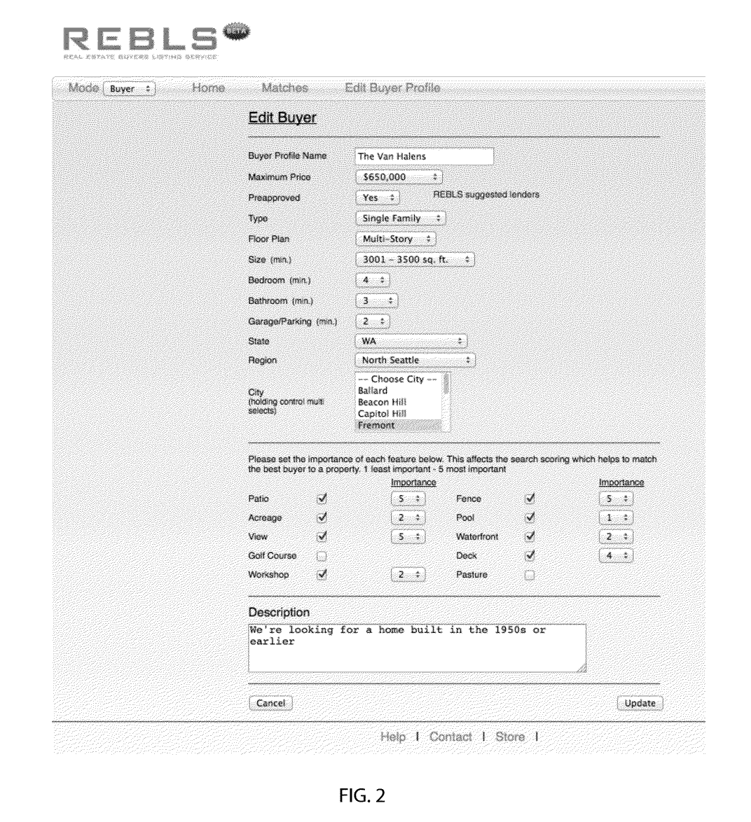

After arriving at the homepage GUI, unregistered visitors to the website may click on a registration link that points to a webpage for registering their name and address. FIG. 1 shows an example of a registration page GUI as it would typically appear, wherein the fields (numbers) in the example GUI of FIG. 1 are populated using fictitious data personal data, such as name and address. Once registration is complete, the user clicks on the registration button, and is informed of successful registration and that a security activation link has been sent to them by e-mail. Once registration is activated, the user may wait to receive an e-mail to confirm identity and providing a link to the homepage of the buyer-seller matching website, as is typically done in the art, where the user may proceed to log in and input appropriate search criteria. Once logged in, the user may identify him or herself as a buyer by selection from a Mode drop-down menu. As a buyer, the user may then select an edit buyer profile menu, wherein a screen is presented to the buyer for inputting desired profile values. An example of the buyer profile screen is shown in FIG. 2.

The buyer may then specify his or her property search criteria by selection of pre-programmed values from a series of dropdown menus configured on the webpage as shown in FIG. 2. However, it may be appreciated that other data entry options can be used, such as radio buttons or check boxes. Data entries may include, but are not limited to, the type of dwelling the buyer is interested in purchasing, the price range, the floor plan type, the square footage (size in dwelling area), the minimum number of bedrooms, baths and parking capacity. As examples, the buyer may choose between a single family home, a condominium, commercial property such as an apartment or office building or land. For a dwelling, a selection of floor plan types can be presented to the buyer, providing choices of single level, split level, or multilevel floor plans. An entry point for size of the property in terms of living space or surface area, for example, square footage or meters square, may be selected from a predetermined selections. The buyer may also input the range of interest in an input field for a value, such as price range. The desired number of bedrooms, baths, garage space (parking spaces) can also be input fields for which the buyer provides data. Furthermore, the buyer can input regional descriptor, such as a particular state, city or community, and neighborhood to which the search may be confined. Again, the fields can be provided in the form of drop-down menus, radio buttons, check boxes, and the like. An input field may also be provided to include comments by the buyer to further describe or elaborate their desires or buying criteria that are not “hardwired” in the profile data capture page. Comments in the comment field may generate metadata that may be used by the innovative method software to further enhance the property search for the buyer. Buyers' input data from this screen (FIG. 2) are then stored in a buyer results data structure, such as an array, in the database data structure occupying physical memory on the URL server.

In the preferred embodiment of the invention, the profile page provides for input of a plurality of desired property attributes or features that only require a yes/no input, whereby the buyer selects property attributes or features that are desirable to the buyer in addition to the basic information provided in the fields requiring numerical input. Examples of such property attributes or features for a home, for example, is shown at the bottom of the example GUI shown in FIG. 2. When a feature is selected, as demonstrated in FIG. 2, the buyer is asked to provide a subjective score for the attribute or feature, indicating the level of importance to the buyer by selecting a numerical value ranging from, for example, 1-5, via a dropdown menu that appears for each feature selected. The buyer then selects a numerical importance score value representing the relative importance of the particular attribute or feature plays in making a purchase decision for a property such as a home.

This numerical importance score value may also be stored in the buyer results data structure. In some embodiments of the invention, the buyer may also be required to provide information on lender pre-approval status. Some sellers may prefer to only accept offers from pre-approved buyers. By way of example, buyers who have not been pre-approved by a lender may be presented with links to recommended lenders' websites or to downloadable or web-fillable application forms in order to initiate an approval process if they so desire.

Preferably, once registration is complete, the software creates a data structure to receive the newly entered data for the buyer. The data structure may be appended to the database maintained by the buyer-seller matching website, wherein the database comprises data structures for a plurality of registered buyers.

Search Inventory from Properties not for Sale

It is an object of the inventive method to also make accessible to buyers searching the buyer-seller matching website properties that have not yet been placed on the market. That is, it is an object of the invention to list properties that exist with a geographical location, such as a neighborhood, town, city or county, and have not, up until the time of acquisition of data for the property, that are not currently for sale. For instance, information on homes that are not listed on the Multiple Listing Service (MLS), not listed with a real estate agency or otherwise knowingly for sale may be made available to buyers registered on the buyer-seller matching website or casual visitors browsing on the website. Accordingly, the inventive buyer-seller matching method further comprises an inventory of data on all existing properties within a specific legal jurisdiction, such a county, or a geographical location such as a town or neighborhood of a large city, into a database maintained by the buyer-seller matching website For real properties existing in most states in the United States, for example, the counties are the legal jurisdiction that taxes property, and keeps property statistics and other vital information in tax records kept by county tax offices. These records may be accessed by the public to obtain data on all homes having an address within the borders of a county.

According to the invention, data purchased or otherwise obtained from county tax records may be stored in a database maintained by the buyer-seller matching website and organized into fields containing important attribute statistics, such as square footage, number of bedrooms, baths, lot size and type, etc., in a data structure created for the data associated with each property obtained from the county tax records. One or more photographs of the homes may also be included as part of the data. The fiscal data obtained from tax records may disclose the assessed tax value of the properties, which typically is well below market value. However, an estimate may be made of the true market value of a property that is not listed for sale, for instance by computing a multiplication factor based on the ratio of the averaged market value of a group of similar properties that have been sold (so-called comps) to their average assessed tax value, whereby the tax value of any property similar to the comps may be multiplied by the same computed multiplication factor to provide an estimate of its true market value. This method may be repeated for all properties not for sale within a geographical location, such as a particular neighborhood.

A buyer logging on to the buyer-seller matching website may browse the database of unlisted homes and come upon a particular home, that, according to the statistics included with the listing, may be of interest to the buyer. The buyer may have one or more ways to express interest in the unlisted property. As an example, the buyer may want to contact the homeowner immediately. In such a case, the buyer can generate a tag that will direct the website software to automatically generate a letter addressed to the homeowner, informing the homeowner that there the buyer expresses interest in making contact explore the homeowner's interest in selling the home, and may include the buyer's contact information, or the buyer may remain anonymous, depending on the buyer's level of interest. The letter may also invite the homeowner to register with the website.

Secondarily, if the buyer is not interested in contacting the homeowner directly, the buyer may generate a tag directing the website software to mark the property in question, indicating that (anonymous, or passive) interest has been expressed for the particular property, of which a tag is attached to the property in the database. The user may do this by selecting an indicator on the GUI of the webpage, such as a radio button, or by entering text into a text input window. In some instances, more than one buyer may express anonymous or passive interest in the same property. According to the invention, the website may generate a letter to the homeowner that one ore more buyers (registered or not) have expressed interest in the property, and invite the homeowner to visit the website, and if interest on the part of the homeowner is sparked by the desirability of the property, to register as a seller.

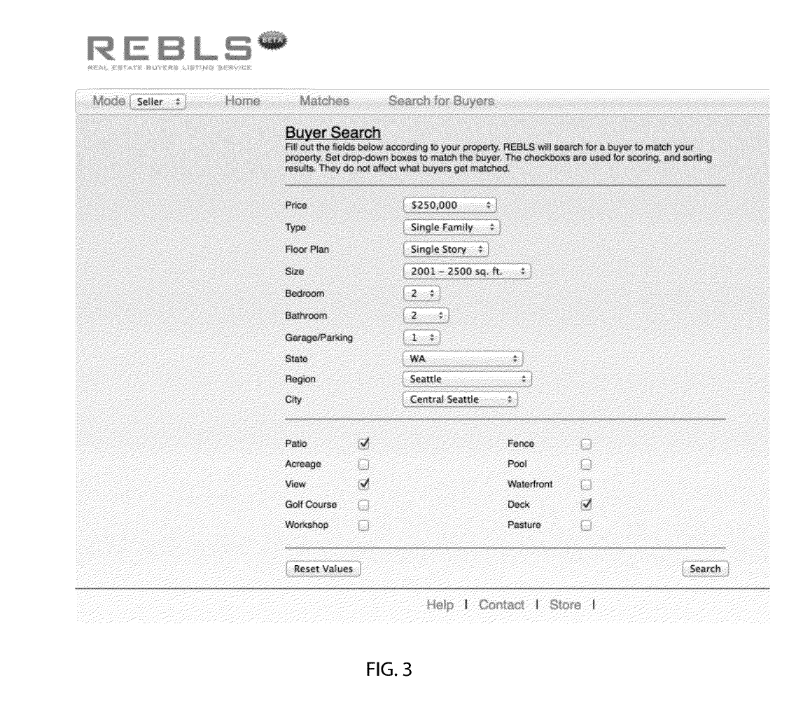

To register as a seller, a property owner visits the website and opens the registration page. [If a user is selling property and seeks to find potential buyers registered on the website for the property that the user is selling,] The seller [they] selects the ‘Seller’ option from the Mode dropdown menu to identify him or herself as a seller, as shown by example in FIG. 3. The seller may then click on the Search for Buyers menu heading to open a property profile page as shown in FIG. 3. and input data on the property that is being offered. As an example as shown in FIG. 3, the seller may input values of a property descriptor: size of the living space in terms of surface area, number of bedrooms, number of baths, number of spaces in a garage, and the like. The basic property descriptor data input fields in FIG. 3 may be similar to, or may be the same, as the buyer input fields.

Near the bottom of the seller profile creation screen shown in FIG. 3, a plurality of check boxes are presented to the seller wherein the check boxes correspond to descriptors for property features that only require a yes/no indication. The seller may check the boxes corresponding to property descriptors that are applicable to the seller's property. For example, if the seller is offering a home for sale, the seller may indicate that the home has a view, a patio and a deck (FIG. 3). By way of the buyer profile screen, an identical set of property descriptors are presented to buyers. As seen in the lower portion of the buyer profile screen shown in FIG. 2, a dropdown menu is associated with each feature descriptor so that the buyer may subjectively rank the feature descriptor in order of importance that the buyer places on the particular feature.

One of the functions of the invention is to provide an enhanced buyer-seller match, whereby a cohort of candidate buyers matched to a particular seller is provided to that seller via the inventive matching engine. The matching engine is embodied as a refined match-scoring algorithm that may be embedded as a subroutine or module of the web software. The matching engine scores buyers whose property preference profile matches a seller's property profile in by the basic property descriptors.

Advantageously, the inventive algorithm goes beyond the basic function of matching basic property descriptors in the buyer profile to the seller profile to numerically rank or score the match according to the numerical importance rankings as determined by the buyer at the time the profile was created or updated, as shown at the bottom of the screen in FIG. 2. The inventive algorithm advantageously performs the numerical ranking of a match by summing the numerical values of the importance rankings placed on the property features by the buyer, thereby providing a refined match list of buyers to the seller.

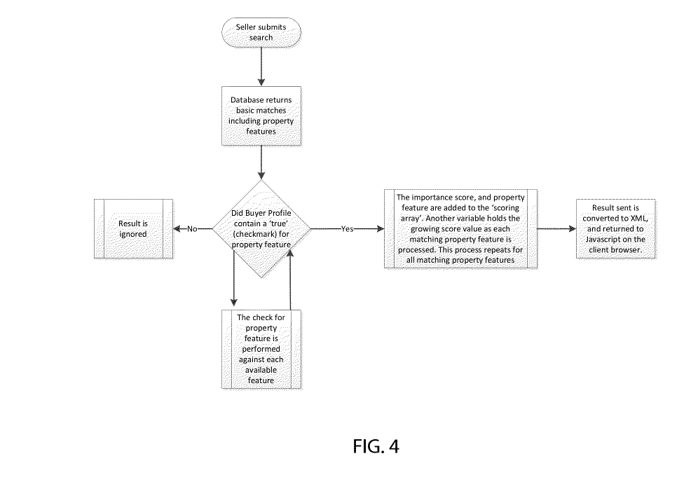

An example of the basic functions of the matching algorithm that is performed by the buyer-seller matching website software is shown in the flowchart of FIG. 4. The example shows a match performed by the algorithm to find buyers for a property offered by a particular seller. As a first step, a seller profile is first submitted to the algorithm by clicking the ‘Search’ button on the lower right hand portion of the screen shown in FIG. 3. The inventive buyer-seller matching algorithm then first executes a basic match function by finding the buyer profiles that contain field values matching the corresponding field values in the seller's profile. The inventive algorithm performs these steps for basic matching by sorting profile input fields entered by all registered buyers, and compiles them into data structures, such as arrays, for each entry category. The routine matches the buyers' data collectively in accordance with a matching routine, discussed in detail below, that compares each datum in the database with the seller's data input.

The algorithm first matches price points indicated by price field data entered by the seller and by the buyers upon registration. Buyers have entered a price range that they may be willing to pay for a property, and the seller has previously entered a price range that he or she may willing to accept for the offered property. By way of example, as a first step, buyers entered ceiling price value needs to be equal to or greater than the seller's entered floor price value. As an example, suppose the seller has made a price entry of $350,000 for a particular property. Buyers who have made a selection from a drop-down menu presenting price ranges in increments of $50,000, wherein a price range of $300,001-$350,000, thereby encompassing the seller's price of $350,000, are then deemed to match the first criterion. The matching finds all buyers in the registered buyer database matching this first criterion, and may then create a temporary database representing a first cohort of these buyers that match this first criterion, the first cohort being a subset of all registered buyers.

As a second step, the algorithm may search among the buyers in the first cohort for matches based on living space. For living area size of a single family dwelling, the seller may have entered a value of 2500 square feet. All registered buyers are prompted to enter values for a desired size range of a single family dwelling into the living area field upon registration. The matching routine may then find the buyers within the first cohort have selected a range of living space size encompassing 2500 square feet. By way of example, a series of size (area) ranges in increments of 500 square feet are presented to the buyer in a drop-down menu. Those buyers in the first cohort that had selected the choice of 2001-2500 square feet are found are then may be organized into a second cohort of buyers.

The next criterion on the list is then searched amongst these buyers. For example, the minimum number of bedrooms, bathrooms and garage space entered by the buyers are compared to the seller's entered values for these fields. If the property is a two-bedroom home, this is matched to all buyers included in the second cohort who entered at least a one-bedroom minimum, but eliminates those who chose a minimum of three bedrooms. The matching process continues according to the afore-mentioned algorithm until all the entry fields have been exhausted, and culls buyers not matching the criteria, creating new cohorts as each field is matched, wherein the number of buyers in the successive cohorts may shrink as buyers are culled. A final buyer cohort is created after the last field is processed, whereby the final buyer cohort represents a list of basic buyer-seller matches.

According to the invention, after returning the basic matches that include the basic property fields, the inventive algorithm (FIG. 4 flowchart) will next refine the matches by executing a scoring function, whereby the property attributes, or features to which the buyers have assigned a subjective importance score value, are compared and matched; if a match occurs, the numerical importance score value for that feature is captured and stored in a scoring array. The score is also added to a running sum variable that grows as each matching property feature is processed by the algorithm. The scoring function of the inventive algorithm repeats these steps until the feature list is exhausted, where the running sum variable now holds the sum result of the importance scores. Accordingly, the inventive algorithm then converts the result, which can be considered an overall importance score, to XML, which may be then returned to Javascript on the client browser. An example of the XML result is shown below in Table 1.

TABLE 1
Example of XML response containing the overall property importance score

<result>
<buyer>
<id>157</id>
<self>false</self>
<price>350000</price>
<size>3001-3500</size>
<garage>3</garage>
<fence>f</fence>
<fence_pri>1</fence_pri>
<patio>t</patio>
<patio_pri>1</patio_pri>
<deck>f</deck>
<deck_pri>1</deck_pri>
<bedroom>3</bedroom>
<bathroom>3</bathroom>
<type>singlefamily</type>
<floorplan>single story</floorplan>
<acreage>f</acreage>
<acreage_pri>1</acreage_pri>
<pool>t</pool>
<pool_pri>3</pool_pri>
<view>f</view>
<view_pri>1</view_pri>
<waterfront>t</waterfront>
<waterfront_pri>3</waterfront_pri>
<golfcourse>f</golfcourse>
<golfcourse_pri>1</golfcourse_pri>
<region>Snohomish</region>
<description></description>
<handle_name>Test</handle_name>
<visible>t</visible>
<state>wa</state>
<preapproved>false</preapproved>
<workshop>f</workshop>
<workshop_pri>1</workshop_pri>
<pasture>f</pasture>
<pasture_pri>1</pasture_pri>
<score>7</score>
</buyer>
</result>

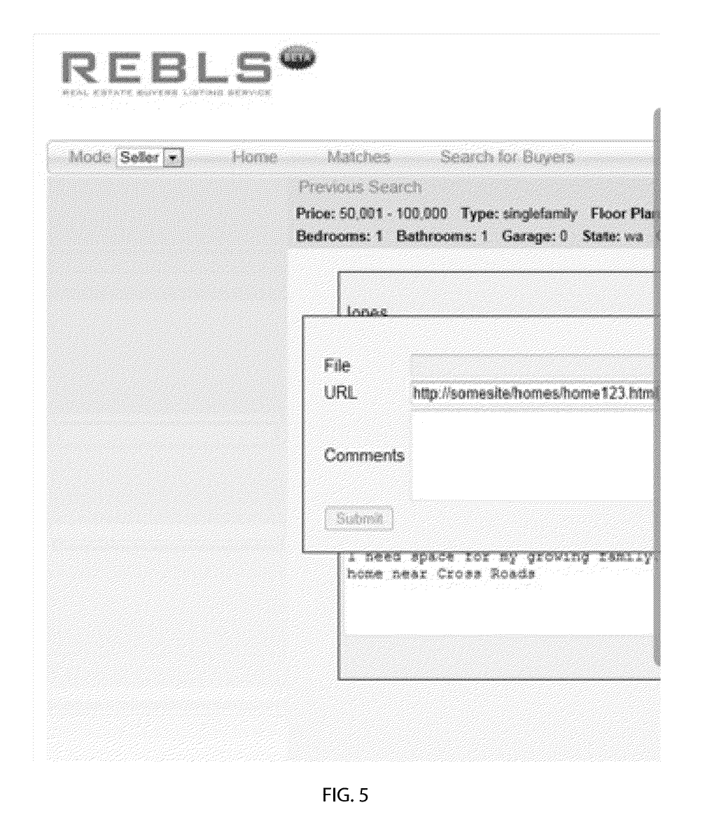

At this juncture, the seller can select the preferred buyers based on the refined ranking performed by the inventive matching routine. The seller is then presented with a window that allows the seller to provide a URL to a property along with a description of the property, and send this to the preferred buyers. This can be done for instance by means of an e-mail offer to the selected preferred buyers for notification that an offer has been extended by the seller. An example of such a window is shown in FIG. 5.

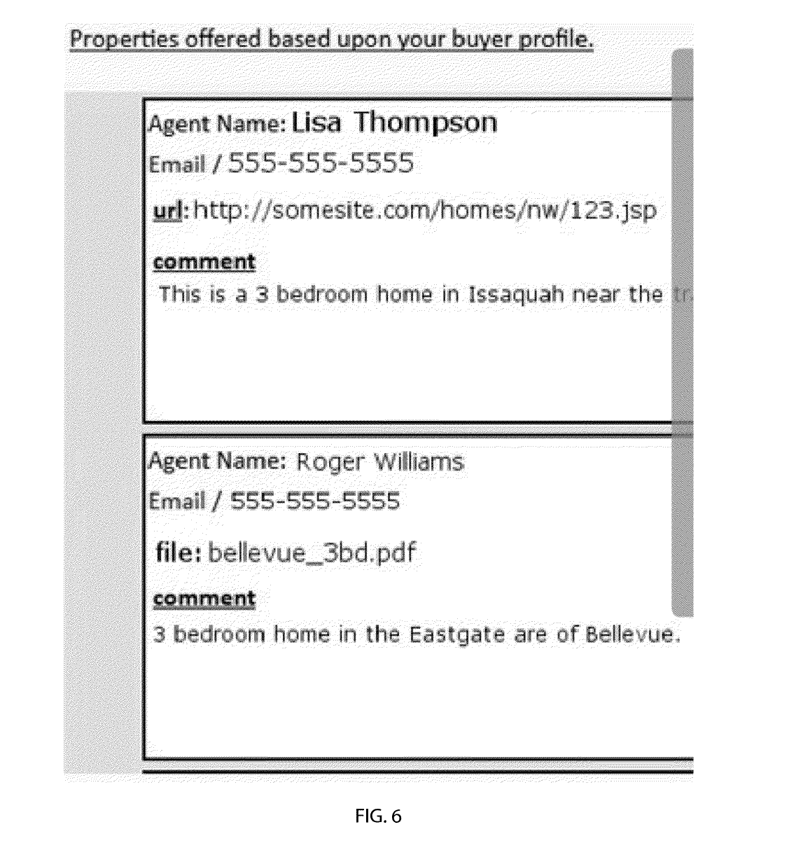

Once such notification has been received by the selected preferred buyer or buyers, the latter can login to the website to examine the details of the offer extended by the seller. Details such as the property description, photographs of the property, a virtual tour and the like, are presented to the buyer or buyers. The buyer or buyers can decide at this juncture if they are interested in the offer or not. If so, they can make contact with the seller via contact details, such as e-mail or telephone, contained in the information presented on the seller website. Buyers may make decisions based on the age, aesthetic qualities, state of repair and location, among others, of the particular property. An example of a match e-mail sent to a buyer is shown in FIG. 6.

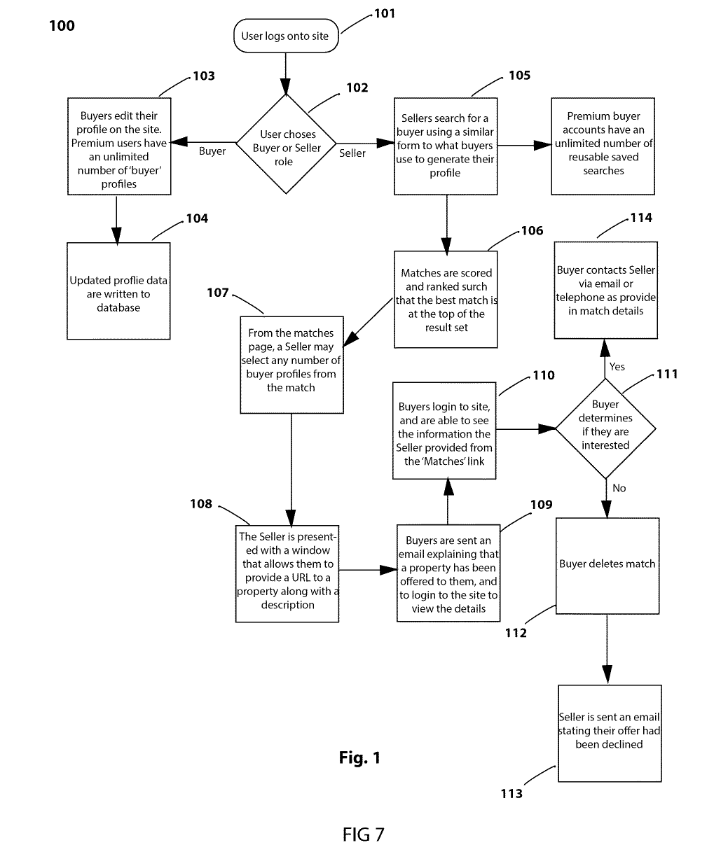

The foregoing description has highlighted the inventive buyer-seller matching algorithm portion of the functional software kernel of an internet-based user interface. A complete description of the software kernel comprising the inventive matching algorithm portion is presented in the flowchart of FIG. 7, and will now be described.

### FLOWCHART EXAMPLE

A flowchart 100 summarizing the process is shown in FIG. 7. The first step of the process is user creation of a profile and registration (not shown). Once registered, the user opens the site and executes step 101 of logon for the first time or after the first time to update the input fields. A user identity and password that were user-specified during registration are given. In step 102, the user chooses a designation of ‘buyer’ or ‘seller’. If the ‘buyer’ designation is chosen, then the user is presented with a window wherein the buyer edits their profile by entering descriptor information into the input fields regarding the desired characteristics that they are looking for in step 103. Examples of the type of descriptor information on the desired characteristics have been discussed above. A user can designate him or herself as a premium user whereby the user can create an unlimited number of profiles. The buyer profile or profiles are then written to a database in step 104.

On the other hand, if the ‘seller’ designation is chosen, the seller inputs descriptors about the property offered for sale into a database in step 105, creating a property profile. In step 106, an inventive algorithm is applied to find matches among the buyer database that best match the seller's property profile. As several criteria are used to determine the matches, the matches have a range of ‘fit’ to the seller's property description. The inventive algorithm scores and ranks the matches to the seller's property profile.

The seller is presented with a ranked match list, as created by the inventive matching algorithm as described above, from which he or she makes a selection of one or more buyer candidates in step 107. Subsequently, in step 108, the seller is then presented with a window that allows he or she to input a URL to a property along with a description. Matched buyers are then sent a software-generated e-mail notification in step 109, explaining that a property has been offered along with an login identification and password to the URL provided by the seller for the seller's property.

Those matched buyers interested in viewing the property then log onto the URL provided by the seller in step 110, with the logon identity and password provided by the seller, and are then able to view the property and the details provided by the seller. In step 111, each of the matched buyers makes the decision to pursue interest in the property or not. A buyer may decide they he or she is not interested in moving forward with the particular seller's offer, and decides to decline. The buyer then deletes the match in step 112, whereby a software generated e-mail containing the notification that the offer was declined by the buyer is sent to the seller in step 113. Conversely, the buyer makes the decision that he or she is interested in moving forward with the particular seller's offer in step 112, and subsequently contacts the seller directly by e-mail or telephone in step 114.

While the foregoing embodiments are described as the preferred embodiment of the invention and serves as an example of the invention, it will be appreciated that particular aspects of the invention are in no way limited to the description above, and that variations in the method of carrying out the invention are within the spirit and scope of the invention. It will also be appreciated that while the foregoing description is directed to real estate transactions, the embodiments of the invention can be broadly applied to buyer-seller matching for other types of transactions.

1. A method for enhanced matching of buyers seeking to buy property with a seller offering property for sale, comprising:
(i) providing a buyer database for storing data entered by a plurality of buyers registered on a buyer-seller matching website, said buyer database comprising a plurality of data structures, each data structure of the plurality being assigned to store the data entered by a single buyer of the plurality of registered buyers, the number of data structures equaling the number of registered buyers
(ii) prompting a first user to log onto the buyer-seller matching website as a buyer searching for a property offered for sale and enter personal data;
(iii) prompting the buyer to enter one or more property search attribute descriptors and to assign a numerical importance score to each of the one or more entered property attribute descriptors;
(iv) creating data structures in the buyer database for storing the personal data, property search attribute descriptor data and numerical importance score data entered by the buyer;
(v) storing each of said one or more property search attribute descriptors and associated numerical importance score values assigned thereto that are entered by the buyer in the created data structures located in the buyer database, wherein created data structures hold the one or more property search attributes and the associated numerical importance scores entered by the buyer the created data structures are added to the plurality of buyer data structures stored in the buyer database;
(vi) providing a seller database for storing data entered by a plurality of sellers registered on a buyer-seller matching website, said seller database comprising a plurality of data structures, each data structure of the plurality being assigned to store the data entered by a single seller of the plurality of registered sellers;
(vii) prompting a second user to log onto the buyer-seller matching website as a seller searching for a property offered for sale;
(viii) prompting the seller to enter one or more property attribute descriptors;
(ix) creating one or more data structures in the seller database for storing the personal data descriptors and property attribute descriptors data entered by the seller;
(x) storing each of said one or more property attribute descriptors that are entered by the seller in the one or more created data structures created in the seller database, wherein the created data structures that hold the one or more property attributes entered by the seller are added to the plurality of seller data structures stored in the seller database;
(xi) comparing each of the property search attribute descriptors entered by the plurality of buyers to the property attribute descriptors entered by the seller;
(xii) choosing among the plurality of buyers those buyers that have at least one search attribute matching a property attribute entered by the seller for amassing a cohort of buyers to present to the seller of the offered property;
(xiii) summing the importance score values stored in the array for each buyer of the cohort;
(xiv) ranking each buyer of the cohort according to the sum value of importance scores;
(xv) sorting each buyer of the cohort by ranking order and compiling a refined list thereof; and
(xvi) presenting the refined list of ranked buyers of the cohort to the seller of the offered property.

2. The method of claim 1, wherein the step of prompting the buyer to enter one or more property search attributes and to assign a numerical importance score to each of the one or more entered property attributes is enabled by a graphical interface on the buyer-seller matching website, said graphical interface comprising a plurality of data entry windows, each data entry window corresponding to a unique property feature chosen from a plurality of property features.
